(19) United States
(12) Patent Application Publication
(10) Pub. No.: US 2014/0036045 A1
(43) Pub. Date: Feb. 6, 2014

(54) IMAGE PROCESSING APPARATUS, IMAGE PROCESSING METHOD, AND PROGRAM

(71) Applicant: Sony Corporation, Tokyo (JP)

(72) Inventors: Keita Ishikawa, Tokyo (JP); Isao Ohashi, Kanagawa (JP)

(73) Assignee: Sony Corporation, Tokyo (JP)

(21) Appl. No.: 13/951,706

(22) Filed: Jul. 26, 2013

(30) Foreign Application Priority Data
Jul. 31, 2012 (JP) 2012-169563

(51) Int. Cl. H04N 13/04

(52) U.S. Cl. CPC H04N 13/0409
USPC 348/51

(57) ABSTRACT

Provided is an image processing apparatus including an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen, a disparity determination unit configured to determine a disparity of the determined sub-pixel arrangement, and an image generation unit configured to generate one or two or more images of other viewpoints that are different to a viewpoint of an image represented by the image signal.

### BACKGROUND

The present disclosure relates to an image processing apparatus, an image processing method, and a program.

Examples of a method for making a user recognize an image that is displayed on a display screen as a three-dimensional image include methods that make a three-dimensional image visible to the user by utilizing the disparity of the user, such as a parallax barrier method (disparity barrier method) and a lenticular method. By using such methods, a three-dimensional image can be made to appear visible to the user without the use of an external device, such as polarized glasses or liquid crystal shutter glasses.

Further, recent years have seen the spread of apparatuses that, when a display screen is rotated, for example, can be rotated together with the image displayed on the display screen. In such an apparatus, for example, when the display screen is rotated 90°, a state in which the long dimension of the display screen and the horizontal direction of the image match (hereinafter referred to as “horizontal placement state”) and a state in which the short dimension of the display screen and the horizontal direction of the image match (hereinafter referred to as “vertical placement state”) can be switched by also rotating the image displayed on the display screen by 90°.

In such circumstances, technology is being developed that allows the user to recognize a three-dimensional image in either of two different display screen states. For example, JP-A-2011-17788 describes a technology that, in a parallax barrier method, makes a user recognize a three-dimensional image in either of two different display screen states.

### SUMMARY

For example, when the technology described in JP-A-2011-17788 is used, a three-dimensional image can be recognized by the user in both a horizontal placement state and a vertical placement state, for example. Here, the horizontal placement state and the vertical placement state respectively correspond to the arrangement state of the sub-pixels forming the pixels of the display screen.

However, the technology described in JP-A-2011-17788 does not give any particular consideration to the changes in disparity that may be felt by the user when the horizontal placement state and the vertical placement state are switched, for example. Therefore, when the technology described in JP-A-2011-17788 is used, when the horizontal placement state and the vertical placement state are switched, for example, the user may feel a sense of strangeness resulting from changes in disparity.

According to an embodiment of the present disclosure, there is provided a novel and improved image processing apparatus, image processing method, and program, that are capable of reducing a sense of strangeness that may be felt by a user when the arrangement state of sub-pixels forming the pixels of a display screen has changed.

According to an embodiment of the present disclosure, there is provided an image processing apparatus including an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen, a disparity determination unit configured to determine a disparity of the determined sub-pixel arrangement based on angle information representing an angle at which a parallax element is provided with respect to a reference direction of the display screen and a determination result of the sub-pixel arrangement, and an image generation unit configured to, based on the determined disparity and an image signal, generate one or two or more images of other viewpoints that are different to a viewpoint of an image represented by the image signal. The disparity determination unit is configured to set a disparity determined when the sub-pixel arrangement is determined to be the second arrangement to be greater than a disparity determined when the sub-pixel arrangement is determined to be the first arrangement.

Further, according to an embodiment of the present disclosure, there is provided an image processing apparatus including an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen, and a disparity determination unit configured to determine a disparity of the determined sub-pixel arrangement based on angle information representing an angle at which a parallax element is provided with respect to a reference direction of the display screen and a determination result of the sub-pixel arrangement. A disparity of images of adjacent viewpoints based on a disparity determined when the sub-pixel arrangement is determined to be the second arrangement is greater than a disparity of images of adjacent viewpoints based on the disparity determined when the sub-pixel arrangement is determined to be the first arrangement.

Further, according to an embodiment of the present disclosure, there is provided an image processing method including determining whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen, determining a disparity of the determined sub-pixel arrangement based on angle information representing an angle at which a parallax element is provided with respect to a reference direction of the display screen and a determination result of the sub-pixel arrangement, and generating, based on the determined disparity and an image signal, one or two or more images of other viewpoints that are different to a viewpoint of an image represented by the image signal. In the determination of disparity, a disparity determined when the sub-pixel arrangement is determined to be the second arrangement is set to be greater than a disparity determined when the sub-pixel arrangement is determined to be the first arrangement.

Further, according to an embodiment of the present disclosure, there is provided a program that causes a computer to execute determining whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen, determining a disparity of the determined sub-pixel arrangement based on angle information representing an angle at which a parallax element is provided with respect to a reference direction of the display screen and a determination result of the sub-pixel arrangement, and generating, based on the determined disparity and an image signal, one or two or more images of other viewpoints that are different to a viewpoint of an image represented by the image signal. In the determination of disparity, a disparity determined when the sub-pixel arrangement is determined to be the second arrangement is set to be greater than a disparity determined when the sub-pixel arrangement is determined to be the first arrangement.

According to the embodiments of the present disclosure described above, the sense of strangeness that may be felt by the user when the arrangement state of the sub-pixels forming the pixels of the display screen has changed can be reduced.

### BRIEF DESCRIPTION OF THE DRAWINGS

FIG. 1 is an explanatory diagram illustrating an example of an arrangement of sub-pixels forming pixels on a display screen, and an arrangement of a parallax element;

FIG. 2 is an explanatory diagram illustrating the reason why the user may feel a sense of strangeness resulting from changes in disparity when an arrangement state of sub-pixels forming the pixels of a display screen has changed;

FIG. 3 is an explanatory diagram illustrating an example of the angle at which a parallax element is provided with respect to a reference direction of the display screen;

FIG. 4 is an explanatory diagram illustrating a first arrangement according to an embodiment of the present disclosure and a second arrangement according to an embodiment of the present disclosure;

FIG. 5 is an explanatory diagram illustrating another example of disparity determination processing performed by an image processing apparatus according to an embodiment of the present disclosure;

FIG. 6 is an explanatory diagram illustrating an example of viewpoint image generation processing performed by the image processing apparatus according to an embodiment of the present disclosure;

FIG. 7 is a flowchart illustrating an example of the processing performed in an image processing method according to an embodiment of the present disclosure;

FIG. 8 is a block diagram illustrating an example of a configuration of the image processing apparatus according to an embodiment of the present disclosure; and

FIG. 9 is an explanatory diagram illustrating an example of a hardware configuration of the image processing apparatus according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in the below, the description will be made in the following order.

1. Image processing method according to the present embodiment
2. Image processing apparatus according to the present embodiment
3. Program according to the present embodiment

### (Image Processing Method According to the Present Embodiment)

Before describing the configuration of the image processing apparatus according to the present embodiment, an image processing method according to the present embodiment will be described first. In the following, the image processing method according to the present embodiment will be described based on an example in which the image processing apparatus according to the present embodiment performs the processing performed in the image processing method according to the present embodiment.

(1) Reason why the User May Feel a Sense of Strangeness Resulting from Changes in Disparity

As described above, for example, when a horizontal placement state and a vertical placement state are switched, namely, when the arrangement state of the sub-pixels forming the pixels of the display screen has changed, the user may feel a sense of strangeness resulting from changes in disparity. Before describing the processing performed in the image processing method according to the present embodiment, the reason why the user may feel a sense of strangeness resulting from changes in disparity will be described for a case in which the arrangement state of the sub-pixels forming the pixels of the display screen has changed.

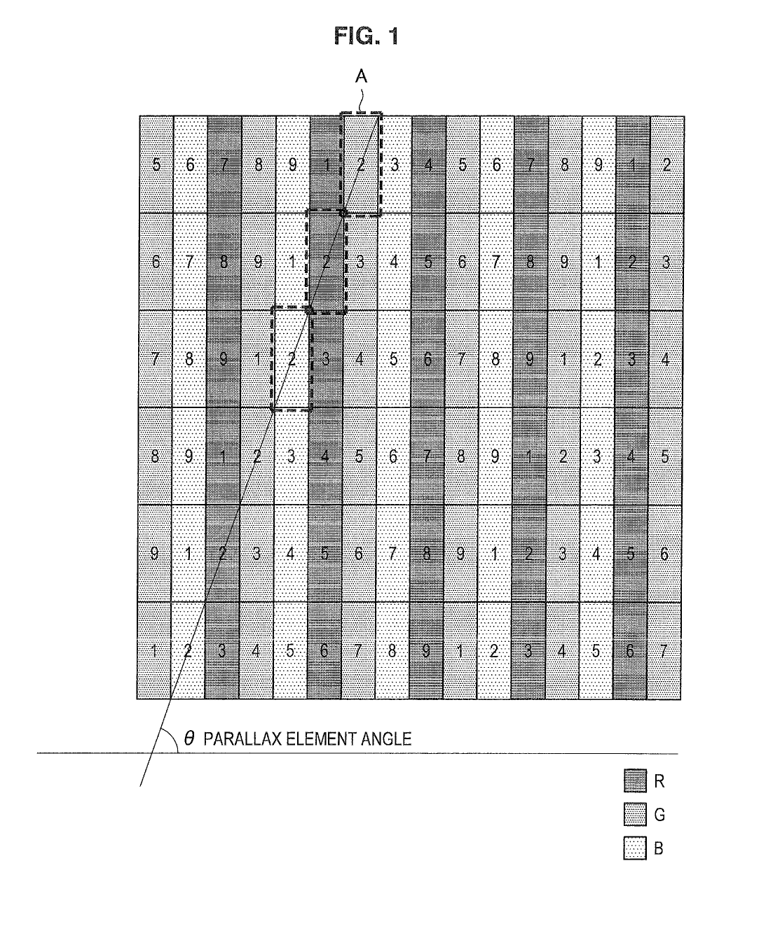

FIG. 1 is an explanatory diagram illustrating an example of an arrangement of sub-pixels forming pixels on a display screen, and an arrangement of a parallax element. In FIG. 1, an example is illustrated in which the display screen pixels are formed from three sub-pixels, R (red), G (green), and B (blue). Further, FIG. 1 illustrates a case in which an image of nine viewpoints (an example of a plurality of viewpoints) is displayed on a display screen. In FIG. 1, the sub-pixels denoted by the number “1” represent a sub-pixel on which an image of the first viewpoint is displayed, and the numbers “2” to “9” denoting the respective sub-pixels in FIG. 1 represent a sub-pixel on which an image of the second to ninth viewpoints is displayed, respectively.

As illustrated in FIG. 1, the images of viewpoints one to nine are repetitively displayed on the sub-pixels forming the pixels of the display screen. Further, the three RGB sub-pixels indicted by the letter A in FIG. 1 form one pixel (in FIG. 1, as an example of a pixel, a pixel on which an image of viewpoint 2 is denoted by reference symbol A, and the same applies to the other pixels as well).

In addition, a parallax element forming a parallax barrier is arranged so as to have an angle θ with respect to a reference direction of the display screen (e.g., a horizontal direction in a horizontal placement state, or a horizontal direction in a vertical placement state).

Here, from the perspective of preventing a deterioration in image quality, the angle θ may be, for example, an angle that matches the angle formed by the reference direction of the display screen and the direction along which the sub-pixels forming one pixel are arrayed. It is noted that the angle θ and the angle formed by the reference direction of the display screen and the direction along which the sub-pixels forming one pixel are arrayed may be the same or different. Further, from the perspective of producing disparity in both a horizontal placement state and a vertical placement state, for example, 0° and 90° are excluded from angle θ.

In the following, as an example, a case will be described in which the reference direction of the display screen is the horizontal direction in a horizontal placement state, and the angle θ and the angle formed by the reference direction of the display screen and the direction along which the sub-pixels forming one pixel are the same.

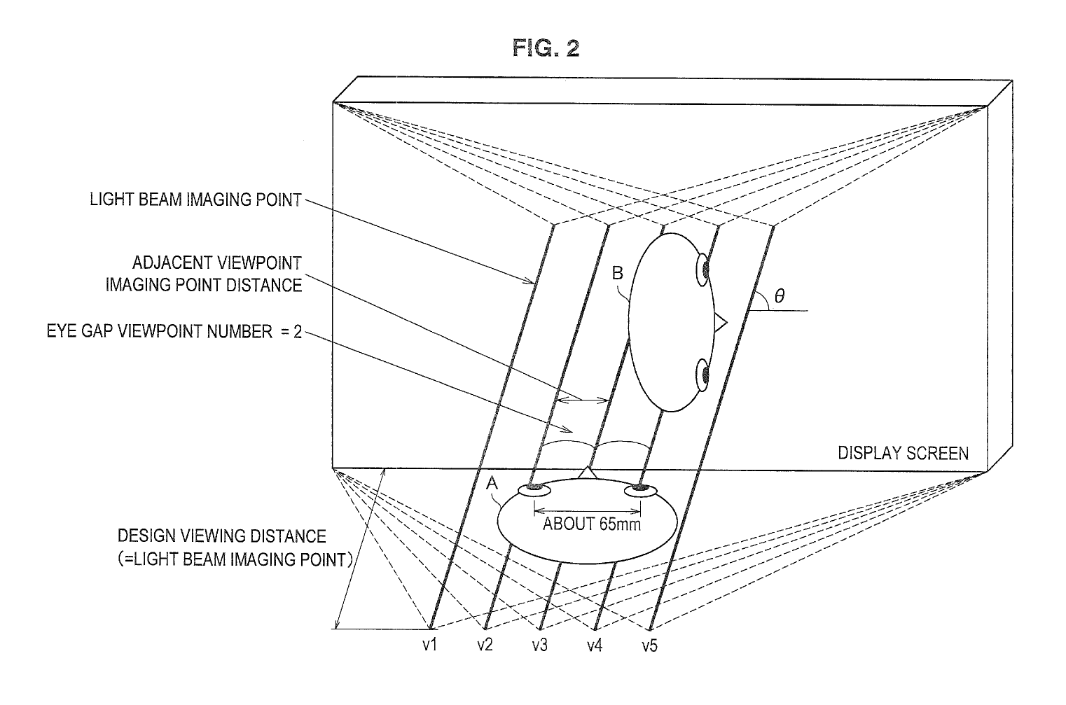

FIG. 2 is an explanatory diagram illustrating the reason why the user may feel a sense of strangeness resulting from changes in disparity when an arrangement state of sub-pixels forming the pixels of a display screen has changed. Letter A in FIG. 2 indicates a user who is viewing an image displayed on a display screen in a horizontal placement state. Further, letter B in FIG. 2 indicates a user who is viewing an image displayed on a display screen in a vertical placement state. In addition, similar to FIG. 1, the angle θ indicated in FIG. 2 represents the angle at which the parallax element is provided with respect to the reference direction of the display screen.

Further, FIG. 2 illustrates a case in which a user's eye gap viewpoint number expressed by the following formula 1 is “2” for the user indicated by letter A in FIG. 2. Here, the eye gap viewpoint number expressed by the following formula 1 is an index corresponding to the disparity perceived by the user. In order to make the user viewing an image displayed on a display screen perceive a three-dimensional image more normally, it is desirable that the user's eye gap viewpoint number is, for example, 0.5 or more. However, even if the eye gap viewpoint number is less than 0.5, it is still possible to make the user viewing the image displayed on the display screen perceive a three-dimensional image normally.

Eye gap viewpoint number=(binocular interval of the user)/(adjacent viewpoint imaging point distance) (Formula 1)

As indicated by letters A and B in FIG. 2, for example, when the horizontal placement state and the vertical placement state are switched (when the display screen is rotated by 90°), the eye gap viewpoint number is changed so that the viewing distance for viewing a three-dimensional image in an ideal state (hereinafter referred to as “optimal viewing distance” or “design viewing distance”) does not change. More specifically, for example, the relationship expressed by the following formula 2 holds between the eye gap viewpoint number in the horizontal placement state indicated by A in FIG. 2 and the eye gap viewpoint number in the vertical placement state indicated by B in FIG. 2. Here, “n_{gap}_{_{—}}ₕ” in formula 2 represents the placement state in a horizontal placement state, and “n_{gap}_{_{—}}_{V}” in formula 2 represents the placement state in a vertical placement state.

n_{gap}_{_{—}}ₕ=n_{gap}_{_{—}}ᵥ×(1/tan θ) (Formula 2)

For example, if tan θ in formula 2 is “3” (e.g., when the angle θ angle matches the angle formed by the direction along which the sub-pixels of a typical RGB array like that illustrated in FIG. 1 are arrayed), in the example illustrated in FIG. 2, the eye gap viewpoint number for A in FIG. 2 is “2”, while the eye gap viewpoint number for B in FIG. 2 is about “0.67”.

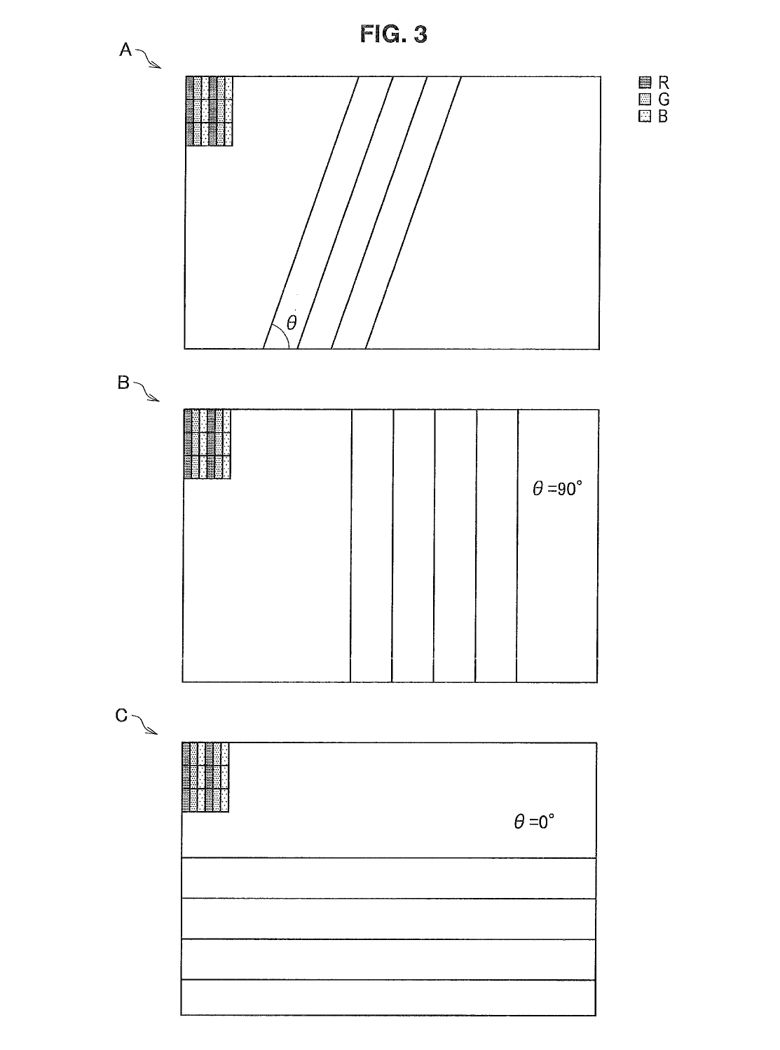

FIG. 3 is an explanatory diagram illustrating an example of the angle at which a parallax element is provided with respect to a reference direction of the display screen. FIG. 3 illustrates the angle θ at which a parallax element is provided with respect to a reference direction of the display screen for a case in which the reference direction of the display screen is the horizontal direction in a horizontal placement state. A in FIG. 3 illustrates an example in which the angle θ is not 0° or 90°. Further, B in FIG. 3 illustrates an example in which the angle θ is 90°, and C in FIG. 3 illustrates an example in which the angle θ is 0°.

Here, as illustrated in FIG. 3B, when the angle θ is 90°, disparity does not occur in a vertical placement state. Further, as illustrated in FIG. 3C, when the angle θ is 0°, disparity does not occur in a horizontal placement state. Therefore, as described above, from the perspective of producing disparity in both a horizontal placement state and a vertical placement state, for example, 0° and 90° are excluded from the angle θ at which the parallax element is provided with respect to the reference direction of the display screen.

As described above, for example, when the horizontal placement state and the vertical placement state are switched, namely, when the arrangement state of the sub-pixels forming the pixels of the display screen has changed, since the eye gap viewpoint number changes without a change in the optimal viewing distance, disparity changes. Therefore, for example, when the horizontal placement state and the vertical placement state are switched, namely, when the arrangement state of the sub-pixels forming the pixels of the display screen has changed, the user may feel a sense of strangeness resulting from the changes in disparity.

### (2) Outline of the Processing Performed in the Image Processing Method According to the Present Embodiment

Next, an outline of the processing performed in the image processing method according to the present embodiment will be described.

As shown in the above formula 2, the eye gap viewpoint number when the arrangement state of the sub-pixels forming the pixels of the display screen has changed depends on the tangent function of the angle θ at which the parallax element is provided with respect to the reference direction of the display screen. Accordingly, for example, if the parallax element is provided so that angle θ is 45°, based on formula 2 the eye gap viewpoint number in the horizontal placement state and the eye gap viewpoint number in the vertical placement state match, so that the change in disparity when the arrangement state of the sub-pixels forming the pixels of the display screen has changed can be eliminated.

However, for example, as illustrated in FIG. 1, typical sub-pixels forming the pixels of the display screen have a short dimension (corresponding to the horizontal direction in FIG. 1) and a long dimension (corresponding to the perpendicular direction in FIG. 1). Therefore, when the display screen is configured from the pixels illustrated in FIG. 1, if the parallax element is provided so that angle θ is 45°, the quality of the image displayed on the display screen deteriorates.

One measure to not only eliminate the change in disparity that occurs when the arrangement state of the sub-pixels forming the pixels of the display screen has changed, but also prevents a deterioration in the quality of the image displayed on the display screen, is to provide the parallax element so that angle θ is 45° and use square sub-pixels for each of the sub-pixels forming the pixels of the display screen. By employing this measure, for example, even when the arrangement state of the sub-pixels forming the pixels of the display screen has changed, there is no change in the design viewing distance or the eye gap viewpoint number, and the sense of depth can also remain unchanged. Consequently, a more natural three-dimensional image display can be realized.

However, as illustrated in FIG. 1, the typical sub-pixels that form the pixels of the display screen are not square sub-pixels. Consequently, to produce a pixel structure that has square sub-pixels would lead to an increase in costs.

Accordingly, when the sub-pixels forming the pixels of the display screen are not square, like in FIG. 1, the image processing apparatus according to the present embodiment reduces the sense of strangeness that may be felt by the user when the arrangement state of the sub-pixels forming the pixels of the display screen has changed by, for example, performing the below-described (1) determination processing, (2) disparity determination processing, and (3) viewpoint image generation processing.

### (1) Determination Processing

The image processing apparatus according to the present embodiment determines whether the arrangement of the sub-pixels forming the pixels of the display screen is a first arrangement or a second arrangement. Here, the display screen according to the present embodiment may be, but is not limited to, a display screen of a display unit (described below) that is included in the image processing apparatus according to the present embodiment. For example, the display screen according to the present embodiment may be a display screen of a display panel included in an external device of the image processing apparatus according to the present embodiment.

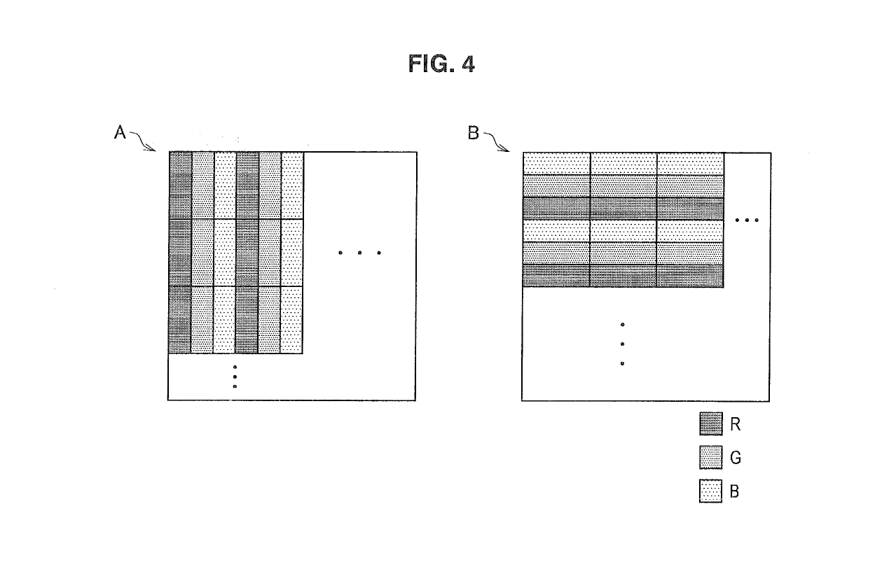

FIG. 4 is an explanatory diagram illustrating a first arrangement according to an embodiment of the present disclosure and a second arrangement according to an embodiment of the present disclosure. Letter A in FIG. 4 indicates the first arrangement according to the present embodiment, and letter B in FIG. 4 indicates the second arrangement according to the present embodiment. Further, FIG. 4 illustrates an example in which the pixels of the display screen are formed from three sub-pixels of R (red), G (green), and B (blue).

As illustrated in FIG. 4A, the first arrangement according to the present embodiment is an arrangement in which the sub-pixels are arranged so that the short dimension of the sub-pixels forming the pixels of the display screen lies in the horizontal direction of the display screen. Further, as illustrated in FIG. 4B, the second arrangement according to the present embodiment is an arrangement in which the sub-pixels are arranged so that the long dimension of the sub-pixels forming the pixels of the display screen lies in the horizontal direction of the display screen. Here, the first arrangement according to the present embodiment corresponds to an arrangement in which, for example, the above-described horizontal placement state is realized, and the second arrangement according to the present embodiment corresponds to an arrangement in which, for example, the above-described vertical placement state is realized.

More specifically, the image processing apparatus according to the present embodiment determines whether the sub-pixel arrangement is a first arrangement (corresponding to a horizontal placement state) or a second arrangement (corresponding to a vertical placement state) based on, for example, a detection signal indicating a detection result made by one or two or more sensors capable of detecting a display screen state, such as an acceleration sensor, an angular velocity sensor, a geomagnetic sensor and the like. The image processing apparatus according to the present embodiment performs processing based on, for example, a detection signal transmitted from the respective sensors included in the apparatus (the image processing apparatus according to the present embodiment) or a detection signal transmitted from an external device corresponding to the display screen, such as an external display device.

It is noted that the determination processing performed by the image processing apparatus according to the present embodiment is not limited to that described above. For example, the image processing apparatus according to the present embodiment may determine whether the sub-pixel arrangement is a first arrangement (corresponding to a horizontal placement state) or a second arrangement (corresponding to a vertical placement state) based on state information (data) transmitted from an external device indicating a display screen state (e.g., a horizontal placement state or a vertical placement state).

### (2) Disparity Determination Processing

Based on the determination result of the above-described processing of (1) (determination processing) and angle information representing the angle θ at which the parallax element is provided with respect to the reference direction of the display screen, the image processing apparatus according to the present embodiment determines the disparity of the sub-pixel arrangement determined by the above-described processing of (1) (determination processing).

Here, the image processing apparatus according to the present embodiment acquires the angle information by, for example, reading angle information stored in a storage unit (described below), reading angle information from a connected external recording medium, or receiving angle information transmitted from an external device (e.g., an external display device, a server etc.). The image processing apparatus according to the present embodiment acquires angle information from an external device by, for example, transmitting to the external device an angle information transmission request that includes a transmission command that makes the external device transmit the angle information.

Further, the image processing apparatus according to the present embodiment sets the disparity determined when the arrangement state was determined to be the second arrangement (arrangement corresponding to a vertical placement state) to be a greater than when the sub-pixel arrangement was determined to be the first arrangement (arrangement corresponding to a horizontal placement state). Describing this from another perspective, based on the determination made in the above manner by the image processing apparatus according to the present embodiment, the disparity of images of adjacent viewpoints based on the disparity determined when the arrangement state was determined to be the second arrangement (arrangement corresponding to a vertical placement state) is set to be greater than the disparity of images of adjacent viewpoints based on the disparity determined when the arrangement state was determined to be the first arrangement (arrangement corresponding to a horizontal placement state).

As shown in the above formula 2, the eye gap viewpoint number in a horizontal placement state arrangement corresponding to the first arrangement is smaller than the eye gap viewpoint number in a vertical placement state arrangement corresponding to the second arrangement by a factor of “1/tan θ”. Therefore, as described above, the image processing apparatus according to the present embodiment can reduce the change in disparity that occurs when the arrangement state of the sub-pixels forming the pixels of the display screen has changed by setting the disparity determined when the arrangement state was determined to be the second arrangement (arrangement corresponding to a vertical placement state) to be greater than the disparity determined when the arrangement state was determined to be the first arrangement (arrangement corresponding to a horizontal placement state).

Therefore, as described above, by setting the disparity determined when the arrangement state was determined to be the second arrangement (arrangement corresponding to a vertical placement state) to be greater than the disparity determined when the arrangement state was determined to be the first arrangement (arrangement corresponding to a horizontal placement state), the image processing apparatus according to the present embodiment can reduce the sense of strangeness that may be felt by the user when the arrangement state of the sub-pixels forming the pixels of the display screen has changed.

### (2-1) First Example of Disparity Determination Processing

More specifically, for example, the image processing apparatus according to the present embodiment determines the disparity of the determined sub-pixel arrangement so that, as shown in the following formula 3, a “value obtained by multiplying the value representing the disparity when the sub-pixel arrangement is determined to be the first arrangement by the absolute value of the tangent function of the angle indicated by the angle information” and a “value representing the disparity when the sub-pixel arrangement is determined to be the second arrangement” are the same value.

Dispᵥ=Dispₕ·|tan θ| (Formula 3)

Here, “Dispᵥ” in formula 3 represents the value of the disparity that is determined when the arrangement state is determined to be the second arrangement state, and “Dispₕ” in formula 3 represents the value of the disparity when the arrangement state is determined to be the first arrangement state. Examples of the disparity value according to the present embodiment include a phase difference between the images of adjacent viewpoints. Here, the phase difference according to the present embodiment is, for example, an index representing the disparity amount between the images of adjacent viewpoints when the disparity amount between an image for the left eye (hereinafter sometimes referred to as “L image”) forming a three-dimensional image and an image for the right eye (hereinafter sometimes referred to as “R image”) forming a three-dimensional image is found to be “1.0”.

It is noted that the disparity value according to the present embodiment is not limited to a phase difference. For example, the disparity value according to the present embodiment may be a value obtained by converting the disparity amount between images of adjacent viewpoints into pixels. In the following, a case will be described based on an example in which the disparity value according to the present embodiment is a phase difference.

Further, the “θ” in formula 3 is the angle at which the parallax element is provided with respect to the reference direction of the display screen indicated by the angle information.

The image processing apparatus according to the present embodiment determines the disparity of the sub-pixel arrangement determined in the above-described processing of (1) (determination processing) by selectively performing the calculation of formula 3 using, for example, a disparity value estimated based on the processing target image signal, a pre-set disparity value, and a disparity value set by a user operation. Here, examples of a disparity value estimated based on the processing target image signal include a value representing the result of a depth estimation for a case in which the image indicated by the processing target image signal is a planar image, and a value representing the result of a disparity estimation for a case in which the image indicated by the processing target image signal is a three-dimensional image.

For example, if a value representing the disparity when the arrangement state is determined as being the first arrangement has been estimated or set, and the arrangement state was determined in the above-described processing of (1) (determination processing) to be the first arrangement (arrangement corresponding to a horizontal placement state), the image processing apparatus according to the present embodiment determines the set value representing the disparity to be the value representing the disparity for a case in which the arrangement state is determined as being the first arrangement. Further, for example, if a value representing the disparity when the arrangement state is determined as being the second arrangement has been estimated or set, and the arrangement state was determined in the above-described processing of (1) (determination processing) to be the second arrangement (arrangement corresponding to a vertical placement state), the image processing apparatus according to the present embodiment determines the set value representing the disparity to be the value representing the disparity for a case in which the arrangement state is determined as being the second arrangement.

Specifically, for example, when the arrangement of the sub-pixels corresponding to the value representing the estimated or set disparity and the arrangement of the sub-pixels determined in the above-described processing of (1) (determination processing) match, the image processing apparatus according to the present embodiment does not perform the calculation shown in formula 3.

Further, for example, if a value representing the disparity when the arrangement state is determined as being the first arrangement (arrangement corresponding to a horizontal placement state) has been estimated or set, and the arrangement state was determined in the above-described processing of (1) (determination processing) to be the second arrangement (arrangement corresponding to a vertical placement state), the image processing apparatus according to the present embodiment determines the value representing the disparity for a case in which the second arrangement is determined by calculating the value representing the disparity for a case in which the arrangement state is determined as being the second arrangement based on the above formula 3. Still further, for example, if a value representing the disparity when the arrangement state is determined as being the second arrangement has been estimated or set, and the arrangement state was determined in the above-described processing of (1) (determination processing) to be the first arrangement (arrangement corresponding to a horizontal placement state), the image processing apparatus according to the present embodiment determines the value representing the disparity for a case in which the arrangement state is determined as being the first arrangement by calculating the value representing the disparity for a case in which the arrangement state is determined as being the first arrangement based on the above formula 3.

Specifically, for example, when the arrangement of the sub-pixels corresponding to the value representing the estimated or set disparity and the arrangement of the sub-pixels determined in the above-described processing of (1) (determination processing) do not match, the image processing apparatus according to the present embodiment performs the calculation shown in formula 3. Here, when performing the calculation shown in formula 3, if a disparity value is set for either the value representing the disparity for when the arrangement state is determined as being the first arrangement (arrangement corresponding to a horizontal placement state) or the value representing the disparity when the arrangement state is determined as being the second arrangement (arrangement corresponding to a vertical placement state), then the image processing apparatus according to the present embodiment can determine the other disparity value.

As described above, the image processing apparatus according to the present embodiment determines the disparity of the sub-pixel arrangement determined in the above-described processing of (1) (determination processing) by selectively performing the calculation of formula 3 using, for example, a pre-set disparity value or a disparity value set by a user operation. For example, by determining the disparity of the determined sub-pixel arrangement so that, as shown in the above formula 3, a “value obtained by multiplying the value representing the disparity when the sub-pixel arrangement is determined to be the first arrangement by the absolute value of the tangent function of the angle indicated by the angle information” and a value representing the disparity when the sub-pixel arrangement is determined to be the second arrangement are the same value, the image processing apparatus according to the present embodiment can eliminate the change in disparity that occurs when the arrangement state of the sub-pixels forming the pixels of the display screen has changed.

Therefore, the image processing apparatus according to the present embodiment can eliminate the sense of strangeness that the user may feel when the arrangement state of the sub-pixels forming the pixels of the display screen has changed by determining the disparity of the sub-pixel arrangement determined in the above-described processing of (1) (determination processing) so that the above formula 3 is satisfied.

It is noted that the disparity determination processing performed by the image processing apparatus according to the present embodiment is not limited to processing that uses the above formula 3.

### (2-2) Second Example of Disparity Determination Processing

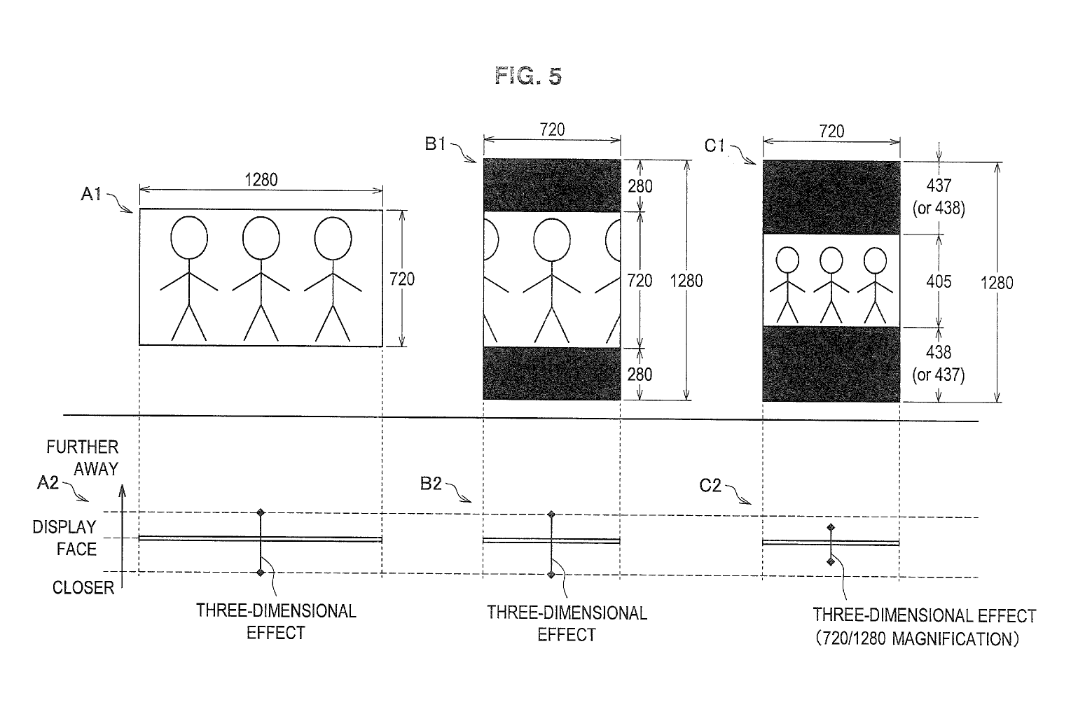

FIG. 5 is an explanatory diagram illustrating another example of disparity determination processing performed by the image processing apparatus according to an embodiment of the present disclosure. A1 in FIG. 5 indicates an example of an image displayed on a display screen in the first arrangement (arrangement corresponding to a horizontal placement state). A2 in FIG. 5 indicates an example of the disparity for A1 of FIG. 5. B1 in FIG. 5 indicates a first example of an image displayed on a display screen in the second arrangement (arrangement corresponding to a vertical placement state), in which the image indicated by A1 of FIG. 5 is displayed on the display screen while maintaining the resolution of the image indicated by A1 of FIG. 5. Further, B2 in FIG. 5 indicates an example of the disparity for B1 of FIG. 5. C1 in FIG. 5 indicates a second example of an image displayed on a display screen in the second arrangement (arrangement corresponding to a vertical placement state), in which the image indicated by A1 of FIG. 5 has been scaled so as to be displayed over the whole display screen. In addition, C2 in FIG. 5 indicates an example of the disparity for C1 of FIG. 5.

For example, as indicated by B1 of FIG. 5, when the image indicated by A1 of FIG. 5 is displayed on the display screen while maintaining the resolution of the image indicated by A1 of FIG. 5, the image processing apparatus according to the present embodiment determines the value indicating the disparity corresponding to the arrangement determined in the above-described processing of processing of (1) (determination processing) by selectively using formula 3.

Further, for example, as indicated by C1 of FIG. 5, when the image indicated by A1 of FIG. 5 is scaled so as to be displayed over the whole display screen, the image processing apparatus according to the present embodiment determines the value that indicates the disparity corresponding to the arrangement determined in the above-described processing of (1) (determination processing) by multiplying the value representing the disparity determined by selectively using formula 3 by a value based on the resolution of the image indicated by A1 of FIG. 2 (in the example illustrated in FIG. 5, “720/1280”). For example, as indicated by C1 of FIG. 5, when the image indicated by A1 of FIG. 5 is scaled so as to be displayed over the whole display screen, by determining the value representing the disparity in the above-described manner, the image processing apparatus according to the present embodiment can provide user with a three-dimensional image that takes the scaling into account.

### (2-3) Third Example of Disparity Determination Processing

Further, when an image is enlarged and displayed on the display screen, the binocular disparity angle increases unless some kind of disparity adjustment is carried out. Therefore, when an image is enlarged and displayed on the display screen, the image processing apparatus according to the present embodiment may adjust the disparity amount (the disparity value determined by the processing performed in the first example described above in (2-1) or the processing performed in the second example described above in (2-2), or an amount corresponding to this disparity value).

Here, one example of adjusting the disparity amount with the image processing apparatus according to the present embodiment is to adjust the disparity amount so that the binocular disparity angle does not exceed one degree (60 minutes), which is a standard set in the guidelines published from the 3D Consortium. It is noted that the standard used in the adjustment of the disparity amount by the image processing apparatus according to the present embodiment is obviously not limited to one degree (60 minutes).

### (3) Viewpoint Image Generation Processing

Based on the disparity determined in the above-described processing of (2) (disparity determination processing) and a processing target image signal, the image processing apparatus according to the present embodiment generates one or two or more images of other viewpoints that are different to the viewpoint of the image represented by the image signal.

Here, examples of the processing target image signal according to the present embodiment include an image signal indicating a planar image and an image signal indicating a three-dimensional image (image signal for the left eye and image signal for the right eye). Further, the image indicated by the processing target image signal according to the present embodiment may be, for example, a still image or a moving image formed from a plurality of frame images.

Further examples of the processing target image signal according to the present embodiment include a signal corresponding to image data read by the image processing apparatus according to the present embodiment from a storage unit (described below) or an external recording medium. It is noted that the processing target image signal according to the present embodiment may be a signal received by a communication unit (described below) or a signal representing an image captured by an imaging unit (described below).

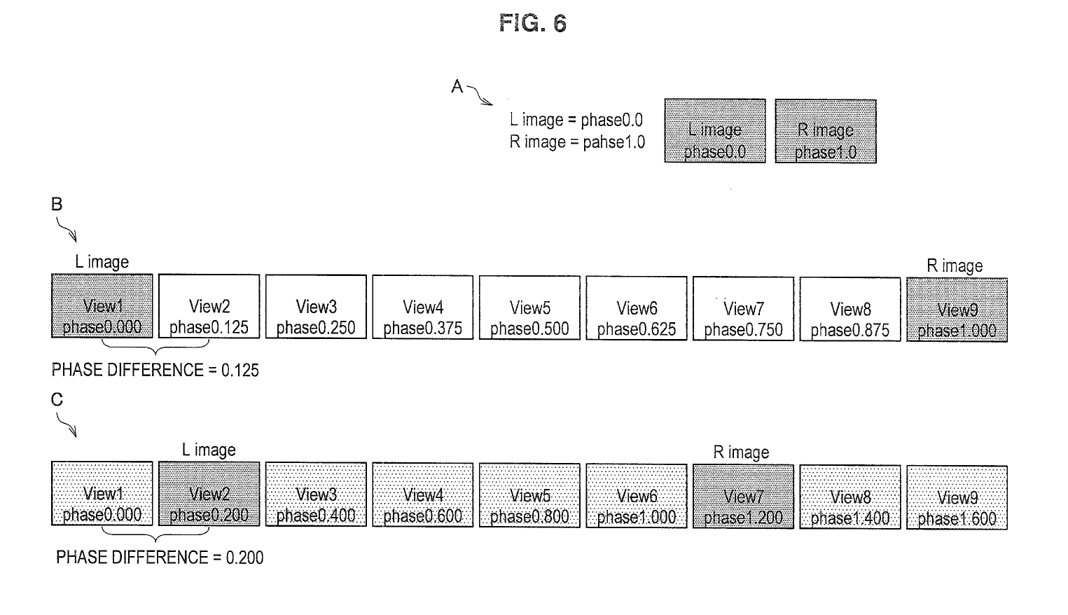

FIG. 6 is an explanatory diagram illustrating an example of viewpoint image generation processing performed by the image processing apparatus according to an embodiment of the present disclosure. Letter A in FIG. 6 indicates an example of an image represented by a processing target image signal, illustrating an image for the left eye that forms a three-dimensional image and an image for the right eye that forms a three-dimensional image. Further, B in FIG. 6 indicates an example of an image of another viewpoint that is generated by the viewpoint image generation processing according to the present embodiment when the phase difference, which is the disparity value determined in the above-described processing of (2) (disparity determination processing) is “0.125”. In addition, C in FIG. 6 indicates another example of an image of another viewpoint that is generated by the viewpoint image generation processing according to the present embodiment when the phase difference, which is the disparity value determined in the above-described processing of (2) (disparity determination processing) is “0.200”. Moreover, in B and C in FIG. 6, an example is illustrated in which images of nine viewpoints, from an image of viewpoint 1 (View 1 in FIG. 6) to an image of viewpoint 9 (View 9 in FIG. 6), are obtained by the viewpoint image generation processing.

The image processing apparatus according to the present embodiment generates an image of another viewpoint by setting one or two images represented by the processing target image signal as a reference image, and generating an image in which the reference image has been shifted by the phase difference determined in the above-described processing of (2) (disparity determination processing). It is noted that the image processing apparatus according to the present embodiment can generate an image of another viewpoint by, for example, performing processing that is based on any viewpoint image generation processing (e.g., multi-viewpoint image generation processing) that is capable of generating images of other viewpoints.

Here, the image processing apparatus according to the present embodiment generates the same number of images of other viewpoints when the arrangement state was determined in the above-described processing of (1) (determination processing) to be the first arrangement (arrangement corresponding to a horizontal placement state) as when the arrangement state was determined in the above-described processing of (1) (determination processing) to be the second arrangement (arrangement corresponding to a vertical placement state), for example. The number of images of other viewpoints generated by the image processing apparatus according to the present embodiment is, for example, a pre-set number or a number set by the user.

It is noted that the viewpoint image generation processing performed by the image processing apparatus according to the present embodiment is not limited to what is described above. For example, the image processing apparatus according to the present embodiment can, when it is determined in the above-described processing of (1) (determination processing) that the arrangement state is the second arrangement (arrangement corresponding to a vertical placement state), generate fewer images of other viewpoints than the number of images of other viewpoints that are generated when it is determined in the above-described processing of (1) (determination processing) that the arrangement state is the first arrangement (arrangement corresponding to a horizontal placement state).

Generally, the length in the horizontal direction of the display screen in a vertical placement state is shorter than the length in the horizontal direction of the display screen in a horizontal placement state. Therefore, even if the image processing apparatus according to the present embodiment generates fewer images of other viewpoints when it is determined that the arrangement state is the first arrangement (arrangement corresponding to a horizontal placement state) than the number of images of other viewpoints that are generated when it is determined that the arrangement state is the second arrangement (arrangement corresponding to a vertical placement state), there is little likelihood that the user who is seeing the image displayed on the display screen will feel a sense of strangeness. Further, the image processing apparatus according to the present embodiment can reduce the amount of processing performed in the viewpoint image generation processing even more by generating fewer images of other viewpoints when it is determined that the arrangement state is the first arrangement than the number of images of other viewpoints that are generated when it is determined that the arrangement state is the second arrangement.

As the processing performed in the image processing method according to the present embodiment, the image processing apparatus according to the present embodiment performs, for example, the above-described processing of (1) (determination processing), the above-described processing of (2) (disparity determination processing), and the above-described processing of (3) (viewpoint image generation processing). In the above-described processing of (2) (disparity determination processing), the image processing apparatus according to the present embodiment determines the disparity of the sub-pixel arrangement determined by the above-described processing of (1) (determination processing), and if it is determined that the arrangement state is the second arrangement (arrangement corresponding to a vertical placement state), sets the disparity to be greater than the disparity that is determined when it is determined that the arrangement state is the first arrangement (arrangement corresponding to a horizontal placement state). Further, in the above-described processing of (3) (viewpoint image generation processing), the image processing apparatus according to the present embodiment generates one or two or more images of other viewpoints based on the disparity determined in the above-described processing of (2) (disparity determination processing) and the processing target image signal.

Here, for example, when the horizontal placement state and the vertical placement state are switched, namely, when the arrangement of the sub-pixels forming the pixels of the display screen has changed between the first arrangement (arrangement corresponding to a horizontal placement state) and the second arrangement (arrangement corresponding to a vertical placement state), although the design viewing distance does not change, the eye gap viewpoint number does change. As described above, in the above-described processing of (2) (disparity determination processing), the image processing apparatus according to the present embodiment determines the disparity so as to correspond to the amount of change in the eye gap viewpoint number, and in the above-described processing of (3) (viewpoint image generation processing), generates images of other viewpoints based on the disparity determined in the above-described processing of (2) (disparity determination processing). Therefore, the image processing apparatus according to the present embodiment can bring the three-dimensional effect felt by the user in the horizontal placement state and the three-dimensional effect felt by the user in the vertical placement state closer together, and further, can also align these effects.

Therefore, the image processing apparatus according to the present embodiment can reduce the sense of strangeness that may be felt by the user when the arrangement state of the sub-pixels forming the pixels of the display screen has changed.

Further, in the above-described processing of (1) (determination processing), the image processing apparatus according to the present embodiment determines whether the arrangement state is the first arrangement (arrangement corresponding to a horizontal placement state) or the second arrangement (arrangement corresponding to a vertical placement state), and then performs the above-described processing of (2) (disparity determination processing) and the above-described processing of (3) (viewpoint image generation processing). Consequently, for example, as illustrated in FIG. 1, even when the sub-pixels forming the pixels of the display screen are not square sub-pixels, the image processing apparatus according to the present embodiment can reduce the sense of strangeness that may be felt by the user when the arrangement state of the sub-pixels forming the pixels of the display screen has changed.

Therefore, since use of the image processing apparatus according to the present embodiment does not lead to an increase in costs due to production of square sub-pixels, the image processing apparatus according to the present embodiment can suppress an increase in costs relating to the pixel configuration of the display screen.

It is noted that the processing performed in the image processing method according to the present embodiment is not limited to the above-described processing of (1) (determination processing) thru (3) (viewpoint image generation processing).

For example, the image processing apparatus according to the present embodiment may display an image indicated by the processing target image signal and the image generated in the above-described processing of (3) (viewpoint image generation processing) on a display screen (display control processing).

Here, when displaying an image on a display screen on an external device, the image processing apparatus according to the present embodiment displays the image on the display screen by, for example, transmitting an image represented by the processing target image signal, an image signal (or image data) representing the generated image, and a processing command for performing processing relating to display on the external device to the external device via a communication unit (nor illustrated). Further, when displaying an image on a display screen of a display unit (described below), the image processing apparatus according to the present embodiment displays the image on the display screen by, for example, transmitting an image represented by the processing target image signal and an image signal (or image data) representing the generated image to the display unit (not illustrated).

It is noted that the display control processing according to the present embodiment may, for example, be performed by an external device capable of communicating with the image processing apparatus according to the present embodiment. When the display control processing according to the present embodiment is performed by an external device, the image processing apparatus according to the present embodiment transmits to the external device, for example, an image represented by the processing target image signal and the image generated in the above-described processing of (3) (viewpoint image generation processing).

### (3) Specific Example of the Processing Performed in the Image Processing Method According to the Present Embodiment

Next, an example of the above-described processing performed in the image processing method according to the present embodiment will be described in more detail. The following description is based on the image processing apparatus according to the present embodiment performing the processing performed in the image processing method according to the present embodiment.

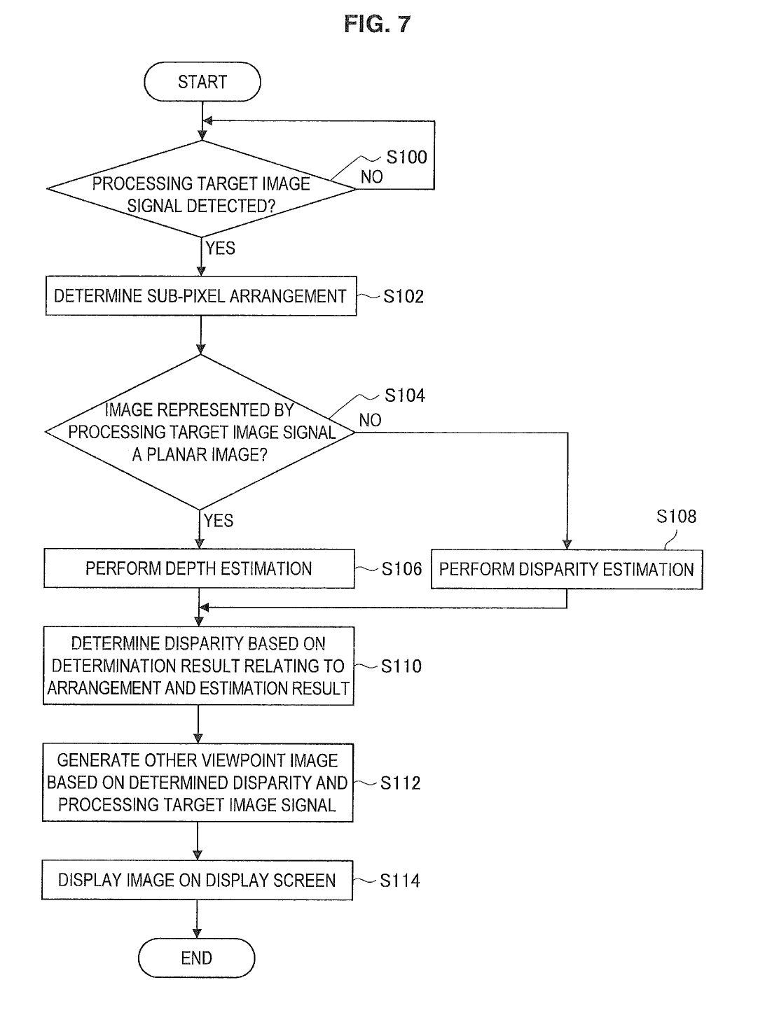

FIG. 7 is a flowchart illustrating an example of the processing performed in an image processing method according to an embodiment of the present disclosure. Here, in FIG. 7, for example, the processing performed in step S102 corresponds to the above-described processing of (1) (determination processing), and the processing performed in steps S104 to S110 corresponds to the above-described processing of (2) (disparity determination processing). Further, in FIG. 7, for example, the processing performed in step S112 corresponds to the above-described processing of (3) (viewpoint image generation processing), and the processing performed in step S114 corresponds to the above-described display control processing.

The image processing apparatus according to the present embodiment determines whether a processing target image signal has been detected (S100). If it is determined in step S100 that a processing target image signal has not been detected, the processing does not proceed until it is detected by the image processing apparatus according to the present embodiment that a processing target image signal has been detected.

If it is determined in step S100 that a processing target image signal has been detected, the image processing apparatus according to the present embodiment determines the sub-pixel arrangement (S102). The image processing apparatus according to the present embodiment determines whether the sub-pixel arrangement is the first arrangement (corresponding to a horizontal placement state) or the second arrangement (corresponding to a vertical placement state) based on, for example, a detection signal indicating a detection result made by one or two or more sensors capable of detecting a display screen state, and the state of the display screen (e.g., a horizontal placement state or a vertical placement state).

The image processing apparatus according to the present embodiment determines whether the image represented by the processing target image signal is a planar image (S104). The image processing apparatus according to the present embodiment determines that the image represented by the processing target image signal is a planar image if, for example, the processing target image signal is not an image signal representing a three-dimensional image (image signal for the left eye, image signal for the right eye).

If it is determined in step S104 that the image represented by the processing target image signal is a planar image, the image processing apparatus according to the present embodiment performs a depth estimation based on the image signal (S106). Here, the image processing apparatus according to the present embodiment estimates the depth of the image represented by the processing target image signal by, for example, using one or two or more results, such as a result of movement detection processing performed using a plurality of time-sequential images, or a result of object detection processing for detecting a specific object (e.g., a person or a thing) from an image. It is noted that the image processing apparatus according to the present embodiment can also perform the processing of step S106 using any technology that is capable of performing a depth estimation.

Further, in step S104, if it is not determined that the image represented by the processing target image signal is a planar image, the image processing apparatus according to the present embodiment performs a disparity estimation based on the image signal (image for the right eye and image for the left eye) (S108). Here, the image processing apparatus according to the present embodiment estimates the disparity by, for example, comparing the image for the right eye and the image for the left eye based on block matching or the like, and calculating the amount of disparity between the image for the right eye and the image for the left eye. It is noted that the image processing apparatus according to the present embodiment can also perform the processing of step S108 using any technology that is capable of performing a disparity estimation.

It is noted that, in FIG. 7, although an example is illustrated in which the processing of steps S104 to S108 is performed after the processing of step S102, the image processing apparatus according to the present embodiment can independently perform the processing of step S102 and the processing of steps S104 to S108. Therefore, the image processing apparatus according to the present embodiment may, for example, perform the processing of step S102 after the processing of steps S104 to S108, or perform the processing of step S102 and the processing of steps S104 to S108 in synchronization.

When the processing of step S102 and the processing of steps S104 to S108 has been completed, the image processing apparatus according to the present embodiment determines the disparity of the sub-pixel arrangement determined in step S102 based on the determination result relating to the arrangement obtained in step S102 and the estimation result obtained in step S106 or step S108 (S110). The image processing apparatus according to the present embodiment determines the disparity of the sub-pixel arrangement determined in step S102 by, for example, selectively performing the calculation of formula 3.

When the disparity is determined in step S110, the image processing apparatus according to the present embodiment generates an image of another viewpoint based on the determined disparity and the processing target image signal (S112). The image processing apparatus according to the present embodiment generates an image of another viewpoint by, for example, setting one or two images represented by the processing target image signal as a reference image, and generating an image in which the reference image has been shifted by the value of the disparity (e.g., phase difference) determined in step S110.

When the processing of step S112 has been completed, the image processing apparatus according to the present embodiment displays the image represented by the processing target image signal and the image generated in step S112 on the display screen (S114).

The image processing apparatus according to the present embodiment performs the processing illustrated in FIG. 7, for example, as the processing according to the present embodiment. Based on the processing illustrated in FIG. 7, the above-described processing of (1) (determination processing) thru (3) (viewpoint image generation processing) and the above-described display control processing are realized. Therefore, by performing the processing illustrated in FIG. 7, for example, the image processing apparatus according to the present embodiment can reduce the sense of strangeness that may be felt by the user when the arrangement state of the sub-pixels forming the pixels of the display screen has changed. Further, by performing the processing illustrated in FIG. 7, the image processing apparatus according to the present embodiment can suppress an increase in costs relating to the pixel configuration of the display screen. It is noted that the processing performed in the image processing method that is performed by the image processing apparatus according to the present embodiment is obviously not limited to the processing illustrated in FIG. 7.

### (Image Processing Apparatus According to the Present Embodiment)

Next, an example will be described of the configuration of the image processing apparatus according to the present embodiment, which is capable of performing the above-described processing performed in the image processing method according to the present embodiment.

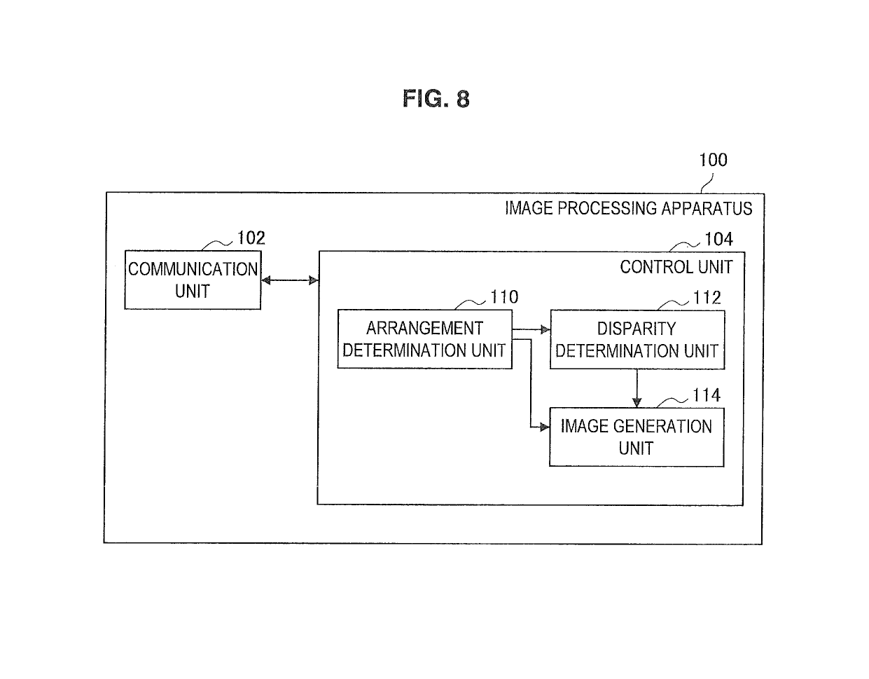

FIG. 8 is a block diagram illustrating an example of a configuration of an image processing apparatus 100 according to an embodiment of the present disclosure. The image processing apparatus 100 includes, for example, a communication unit 102 and a control unit 104.

Further, the image processing apparatus 100 may also include, for example, a ROM (read-only memory; not illustrated), a RAM (random-access memory; not illustrated), a storage unit (not illustrated), a user-operable operation unit (not illustrated), a display unit (not illustrated) that displays various screens on a display screen and the like. The image processing apparatus 100 connects these constituent elements to each other with a bus that serves as a data transmission path.

Here, the ROM (not illustrated) stores control data, such as programs and calculation parameters used by the control unit 104. The RAM (not illustrated) temporarily stores programs and the like that are executed by the control unit 104.

The storage unit (not illustrated) is a storage device included in the image processing apparatus 100, which stores, for example, various data such as image data and applications. Here, examples of the storage unit (not illustrated) include magnetic recording media such as a hard disk, non-volatile memory such as flash memory and the like. Further, the storage unit (not illustrated) may be detachable from the image processing apparatus 100. In addition, examples of the operation unit (not illustrated) include the below-described operation input device. Examples of the display unit (not illustrated) may include the below-described display device.

### (Hardware Configuration Example of the Image Processing Apparatus 100)

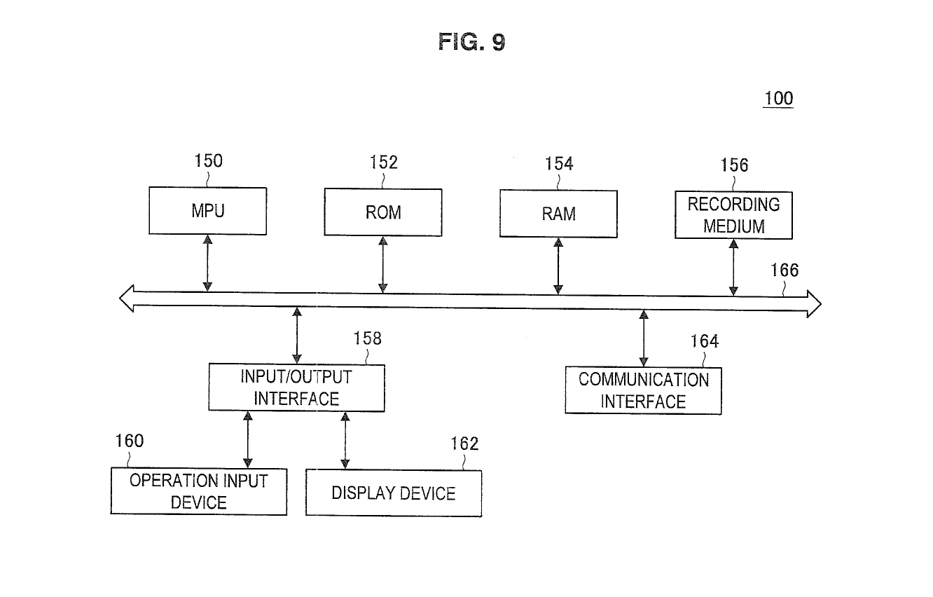

FIG. 9 is an explanatory diagram illustrating an example of a hardware configuration of the image processing apparatus 100 according to an embodiment of the present disclosure. The image processing apparatus 100 includes, for example, a MPU 150, a ROM 152, a RAM 154, a recording medium 156, an input/output interface 158, an operation input device 160, a display device 162, and a communication interface 164. Further, the image processing apparatus 100 connects these constituent elements to each other with a bus 166 that serves as a data transmission path.

The MPU 150 is configured from, for example, a MPU (micro processing unit), various processing circuits and the like. The MPU 150 functions as the control unit 104 for controlling the whole image processing apparatus 100. Further, in the image processing apparatus 100, the MPU 150 plays the role of, for example, the below-described arrangement determination unit 110, disparity determination unit 112, and image generation unit 114.

The ROM 152 stores control data, such as programs and calculation parameters used by the MPU 150. The RAM 154 temporarily stores programs and the like, for example, that are executed by the MPU 150.

The recording medium 156 functions as a storage unit, which stores, for example, various data such as image data and applications. Here, examples of the recording medium 156 include magnetic recording media such as a hard disk, non-volatile memory such as flash memory and the like. Further, the recording medium 156 may be detachable from the image processing apparatus 100.

The input/output interface 158, for example, connects the operation input device 160 and the display device 162. The operation input device 160 functions as a operation unit (not illustrated), and the display device 162 functions as a display unit (not illustrated). Here, examples of the input/output interface 158 includes a USB (universal serial bus) terminal, a DVI (digital visual interface) terminal, a HDMI (high-definition multimedia interface) terminal, various processing circuits and the like. Further, the operation input device 160 is, for example, included on the image processing apparatus 100, and is connected with the input/output interface 158 in the image processing apparatus 100. Examples of the operation input device 160 include a button, a direction key, a rotating-type selector such as a jog dial, or a combination of these. Further, the display device 162 is, for example, included on the image processing apparatus 100, and is connected with the input/output interface 158 in the image processing apparatus 100. Examples of the input/output interface 158 include a liquid crystal display (LCD), an organic EL display (organic electroluminescence display, also called an OLED (organic light emitting diode display)) and the like.

It is noted that the input/output interface 158 is obviously also connected to an external device, such as an operation input device (e.g., a keyboard, a mouse etc.) or a display device, as an external device of the image processing apparatus 100. Further, the display device 162 may also be a device that can perform a display and user operations.

The communication interface 164 is a communication unit included in the image processing apparatus 100, which functions as the communication unit 102 for performing wireless/wired communication with the display device or an external device, such as a server or an imaging device, via a network (or directly). Here, examples of the communication interface 164 include a communication antenna and an RF (radio frequency) circuit (wireless communication), an IEEE 802.15.1 port and a transmitting/receiving circuit (wireless communication), an IEEE 802.11b port and a transmitting/receiving circuit (wireless communication), or a LAN (local area network) terminal and a transmitting/receiving circuit (wired communication) and the like. Further, examples of the network according to the present disclosure include a wired network such as a LAN or a WAN (wide area network), a wireless network such as a wireless LAN (wireless local area network), and wireless WAN (wireless wide area network) via a base station, or the Internet using a communication protocol such as TCP/IP (transmission control protocol/internet protocol) and the like.

Based on the configuration illustrated in FIG. 9, for example, the image processing apparatus 100 performs the processing performed in the image processing method according to the present embodiment. It is noted that the hardware configuration of the image processing apparatus according to the present embodiment is not limited to the configuration illustrated in FIG. 9. For example, the image processing apparatus 100 may include an imaging device that plays the role of an imaging unit (not illustrated) for capturing still images or moving images. If an imaging device is included, the image processing apparatus 100 can process a captured image generated by imaging carried out using the imaging device, for example.

Examples of the imaging device according to the present embodiment include a lens/imaging element and a signal processing circuit. A lens/imaging element is configured from an optical system lens and an image sensor that uses a plurality of imaging elements, such as a CMOS (complementary metal oxide semiconductor). Further, a signal processing circuit includes, for example, an AGC (automatic gain control) circuit and an ADC (analog to digital converter). The signal processing circuit converts an analog signal generated by an imaging element into a digital signal (image data), and performs various kinds of signal processing. Examples of the signal processing performed by the signal processing circuit include white balance correction, color tone correction, gamma correction processing, YCbCr conversion process, edge enhancement processing and the like.

Further, when the image processing apparatus 100 performs processing as a standalone configuration, for example, the image processing apparatus 100 may be configured without the communication interface 164. In addition, the image processing apparatus 100 may also be configured without the operation input device 160 or the display device 162.

An example of the configuration of the image processing apparatus 100 will be described again with reference to FIG. 8. The communication unit 102 is a communication unit included in the image processing apparatus 100, which performs wireless/wired communication with the display device or an external device, such as a server or an imaging device, via a network (or directly). Further, communication by the communication unit 102 is controlled by the control unit 104, for example, Here, examples of the communication unit 102 include a communication antenna and an RF (radio frequency) circuit, a LAN terminal, a transmitting/receiving circuit and the like. However, the configuration of the communication unit 102 is not limited to these examples. For example, the communication unit 102 may have a configuration that supports an arbitrary standard that is capable of performing communication, such as a USB terminal and a transmitting/receiving circuit, or an arbitrary configuration that is capable of communicating with an external device via a network.

The control unit 104 is configured from a MPU, for example, which plays the role of controlling the whole image processing apparatus 100. Further, the control unit 104 which includes, for example, the arrangement determination unit 110, the disparity determination unit 112, and the image generation unit 114, plays the lead role in the processing performed in the image processing method according to the present embodiment.

The arrangement determination unit 110, which plays the lead role in the above-described processing of (1) (determination processing), determines whether the arrangement of the sub-pixels forming the pixels of the display screen is the first arrangement (arrangement corresponding to a horizontal placement state) or the second arrangement (arrangement corresponding to a vertical placement state). More specifically, the arrangement determination unit 110 determines whether the sub-pixel arrangement is the first arrangement or the second arrangement based on, for example, a detection signal indicating a detection result made by one or two or more sensors capable of detecting a display screen state, and the state of the display screen (e.g., a horizontal placement state or a vertical placement state).

The disparity determination unit 112, which plays the lead role in the above-described processing of (2) (disparity determination processing), determines the disparity of the sub-pixel arrangement determined by the arrangement determination unit 110 based on the angle information and the determination result of the sub-pixel arrangement transmitted from the arrangement determination unit 110. More specifically, the disparity determination unit 112 determines the disparity of the sub-pixel arrangement determined by the arrangement determination unit 110 by performing any of the processes described above in (2-1) to (2-3), for example.

The image generation unit 114, which plays the lead role in the above-described processing of (3) (viewpoint image generation processing), generates one or two or more images of other viewpoints that are different to the viewpoint of the image represented by the image signal based on the disparity determined by the disparity determination unit 112 and the processing target image signal.

More specifically, the image generation unit 114 generates an image of another viewpoint by setting one or two images represented by the processing target image signal as a reference image, and generating an image in which the reference image has been shifted by the value of the disparity (phase difference) determined by the disparity determination unit 112. Here, for example, the image generation unit 114 may change the number of other viewpoints to be generated based on the determination result of the sub-pixel arrangement transmitted from the arrangement determination unit 110, or may generate a predetermined number of images of other viewpoints regardless of the determination result of the sub-pixel arrangement. Further, this predetermined number may be set in advance or set by the user.

Since the control unit 104 includes the arrangement determination unit 110, the disparity determination unit 112, and the image generation unit 114, for example, the control unit 104 takes the lead in performing the processing (e.g., the above-described processing of (1) (determination processing) thru (3) (viewpoint image generation processing)) performed in the image processing method according to the present embodiment.

It is noted that the configuration of the control unit according to the present embodiment is not limited to the configuration illustrated in FIG. 8. For example, the control unit according to the present embodiment may further include a display control unit (not illustrated) that performs the above-described display control processing.

Based on the configuration illustrated in FIG. 8, for example, the image processing apparatus 100 performs the processing (e.g., the above-described processing of (1) (determination processing) thru (3) (viewpoint image generation processing)) performed in the image processing method according to the present embodiment. Therefore, based on the configuration illustrated in FIG. 8, for example, the image processing apparatus 100 can reduce the sense of strangeness that may be felt by the user when the arrangement state of the sub-pixels forming the pixels of the display screen has changed. Further, based on the configuration illustrated in FIG. 8, the image processing apparatus 100 can suppress an increase in costs relating to the pixel configuration of the display screen.

It is noted that the configuration of the image processing apparatus according to the present embodiment is not limited to the configuration illustrated in FIG. 8.

For example, the image processing apparatus according to the present embodiment may individually include (e.g., realize with an individual processing circuit) the arrangement determination unit 110, the disparity determination unit 112, and the image generation unit 114 illustrated in FIG. 8 and the display control unit (not illustrated).

Further, for example, the image processing apparatus according to the present embodiment can also be a configuration that does not include the image generation unit 114 that takes the lead in performing the above-described processing of (3) (viewpoint image generation processing). Even if it does not include the image generation unit 114, the image processing apparatus according to the present embodiment can perform the processing according to the present embodiment (e.g., the above-described processing of (1) (determination processing) thru (3) (viewpoint image generation processing)) by performing processing together with an external device that is capable of performing the above-described processing of (3) (viewpoint image generation processing). More specifically, the image processing apparatus according to the present embodiment performs the above-described processing of (1) (determination processing) and the above-described processing of (2) (disparity determination processing), and transmits disparity information (data) representing the determined disparity to the external device. Then, the external device receives the disparity information, and performs the above-described processing of (3) (viewpoint image generation processing).

In addition, the image processing apparatus according to the present embodiment can, for example, include an imaging unit (not illustrated). If it does include an imaging unit, the image processing apparatus according to the present embodiment can process a captured image generated based on imaging by the imaging unit (not illustrated). Examples of the imaging unit (not illustrated) include the above-described imaging device according to the present embodiment.

Still further, when the image processing apparatus according to the present embodiment performs processing as a standalone configuration, for example, the image processing apparatus may be configured without the communication unit 102.

Thus, as the processing performed in the image processing method according to the present embodiment, the image processing apparatus according to the present embodiment performs, for example, the above-described processing of (1) (determination processing), the above-described processing of (2) (disparity determination processing), and the above-described processing of (3) (viewpoint image generation processing). Here, for example, when the horizontal placement state and the vertical placement state are switched, namely, when the arrangement of the sub-pixels forming the pixels of the display screen has changed between the first arrangement (arrangement corresponding to a horizontal placement state) and the second arrangement (arrangement corresponding to a vertical placement state), although the design viewing distance does not change, the eye gap viewpoint number does change. As described above, in the above-described processing of (2) (disparity determination processing), the image processing apparatus according to the present embodiment determines the disparity so as to correspond to the amount of change in the eye gap viewpoint number, and in the above-described processing of (3) (viewpoint image generation processing), generates images of other viewpoints based on the disparity determined in the above-described processing of (2) (disparity determination processing). Therefore, the image processing apparatus according to the present embodiment can bring the three-dimensional effect felt by the user in the horizontal placement state and the three-dimensional effect felt by the user in the vertical placement state closer together, and further, can also align these effects.

Therefore, the image processing apparatus according to the present embodiment can reduce the sense of strangeness that may be felt by the user when the arrangement state of the sub-pixels forming the pixels of the display screen has changed.

Further, in the above-described processing of (1) (determination processing), the image processing apparatus according to the present embodiment determines whether the arrangement state is the first arrangement (arrangement corresponding to a horizontal placement state) or the second arrangement (arrangement corresponding to a vertical placement state), and then performs the above-described processing of (2) (disparity determination processing) and the above-described processing of (3) (viewpoint image generation processing). Consequently, for example, as illustrated in FIG. 1, even when the sub-pixels forming the pixels of the display screen are not square sub-pixels, the image processing apparatus according to the present embodiment can reduce the sense of strangeness that may be felt by the user when the arrangement state of the sub-pixels forming the pixels of the display screen has changed.

Therefore, since use of the image processing apparatus according to the present embodiment does not lead to an increase in costs due to production of square sub-pixels, the image processing apparatus according to the present embodiment can suppress an increase in costs relating to the pixel configuration of the display screen.

Although an image processing apparatus was described above as an embodiment of the present disclosure, the present embodiment is not limited to this example. The present embodiment can also be used in various devices that are capable of processing an image, such as a tablet type device, a communications device such as a mobile phone or a smartphone, a video/audio playback device (or a video/audio recording and playback device), a game device, a computer such as a PC (personal computer), an imaging device such as a digital camera or a digital video camera and the like. Further, the present embodiment can also be applied in a processing IC (integrated circuit) that can be incorporated in such devices.

### (Program According to the Present Embodiment)

By executing on a computer a program (e.g., a program capable of executing the processing performed in the image processing method according to the present embodiment, such as the “the above-described processing of (1) (determination processing) thru (3) (viewpoint image generation processing)”, “the above-described processing of (1) (determination processing) thru (3) (viewpoint image generation processing) and the above-described display control processing” etc.) that makes the computer function as the image processing apparatus according to the present embodiment, the sense of strangeness that may be felt by the user when the arrangement state of the sub-pixels forming the pixels of the display screen has changed can be reduced. Further, by executing on a computer this program that makes the computer function as the image processing apparatus according to the present embodiment, an increase in costs relating to the pixel configuration of the display screen can be suppressed.

It should be understood by those skilled in the art that various modifications, combinations, sub-combinations and alterations may occur depending on design requirements and other factors insofar as they are within the scope of the appended claims or the equivalents thereof.

For example, although a program (computer program) that makes a computer function as the image processing apparatus according to the present embodiment was described above, the present embodiment can further provide a recording medium in which this program is stored.

The above-described configuration illustrates one example of the present embodiment, and naturally comes under the technical scope of an embodiment according to the present disclosure.

Additionally, the present technology may also be configured as below.

(1) An image processing apparatus including:

an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen;

a disparity determination unit configured to determine a disparity of the determined sub-pixel arrangement based on angle information representing an angle at which a parallax element is provided with respect to a reference direction of the display screen and a determination result of the sub-pixel arrangement; and

an image generation unit configured to, based on the determined disparity and an image signal, generate one or two or more images of other viewpoints that are different to a viewpoint of an image represented by the image signal,

wherein the disparity determination unit is configured to set a disparity determined when the sub-pixel arrangement is determined to be the second arrangement to be greater than a disparity determined when the sub-pixel arrangement is determined to be the first arrangement.

(2) The image processing apparatus according to (1), wherein the disparity determination unit is configured to determine the disparity of the determined sub-pixel arrangement so that a value obtained by multiplying a value representing the disparity when the sub-pixel arrangement is determined to be the first arrangement by an absolute value of a tangent function of an angle indicated by the angle information and a value representing the disparity when the sub-pixel arrangement is determined to be the second arrangement are the same value.
(3) The image processing apparatus according to (1), wherein the disparity determination unit determines the disparity of the determined sub-pixel arrangement so as to satisfy the following formula,

Dispᵥ=Dispₕ·|tan θ|

wherein Dispᵥ represents the disparity when the sub-pixel arrangement is determined to be the second arrangement, Dispₕ represents the disparity when the sub-pixel arrangement is determined to be the first arrangement, and θ represents the angle of the parallax element.

(4) The image processing apparatus according to any one of (1) to (3), wherein the image generation unit generates a same number of images of other viewpoints when the sub-pixel arrangement is determined to be the first arrangement as when the sub-pixel arrangement is determined to be the second arrangement.
(5) The image processing apparatus according to any one of (1) to (3), wherein the image generation unit generates fewer images of other viewpoints when the sub-pixel arrangement is determined to be the second arrangement than a number of images of other viewpoints generated when the sub-pixel arrangement is determined to be the first arrangement.
(6) An image processing apparatus including:

an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen; and

a disparity determination unit configured to determine a disparity of the determined sub-pixel arrangement based on angle information representing an angle at which a parallax element is provided with respect to a reference direction of the display screen and a determination result of the sub-pixel arrangement,

wherein a disparity of images of adjacent viewpoints based on a disparity determined when the sub-pixel arrangement is determined to be the second arrangement is greater than a disparity of images of adjacent viewpoints based on a disparity determined when the sub-pixel arrangement is determined to be the first arrangement.

(7) An image processing method including:

determining whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen;

determining a disparity of the determined sub-pixel arrangement based on angle information representing an angle at which a parallax element is provided with respect to a reference direction of the display screen and a determination result of the sub-pixel arrangement; and

generating, based on the determined disparity and an image signal, one or two or more images of other viewpoints that are different to a viewpoint of an image represented by the image signal,

wherein in the determination of disparity, a disparity determined when the sub-pixel arrangement is determined to be the second arrangement is set to be greater than a disparity determined when the sub-pixel arrangement is determined to be the first arrangement.

(8) A program that causes a computer to execute:

determining whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen;

determining a disparity of the determined sub-pixel arrangement based on angle information representing an angle at which a parallax element is provided with respect to a reference direction of the display screen and a determination result of the sub-pixel arrangement; and

generating, based on the determined disparity and an image signal, one or two or more images of other viewpoints that are different to a viewpoint of an image represented by the image signal,

wherein in the determination of disparity, a disparity determined when the sub-pixel arrangement is determined to be the second arrangement is set to be greater than a disparity determined when the sub-pixel arrangement is determined to be the first arrangement.

The present disclosure contains subject matter related to that disclosed in Japanese Priority Patent Application JP 2012-169563 filed in the Japan Patent Office on Jul. 31, 2012, the entire content of which is hereby incorporated by reference.

What is claimed is:

1. An image processing apparatus comprising:
an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen;
a disparity determination unit configured to determine a disparity of the determined sub-pixel arrangement based on angle information representing an angle at which a parallax element is provided with respect to a reference direction of the display screen and a determination result of the sub-pixel arrangement; and
an image generation unit configured to, based on the determined disparity and an image signal, generate one or two or more images of other viewpoints that are different to a viewpoint of an image represented by the image signal,
wherein the disparity determination unit is configured to set a disparity determined when the sub-pixel arrangement is determined to be the second arrangement to be greater than a disparity determined when the sub-pixel arrangement is determined to be the first arrangement.

2. The image processing apparatus according to claim 1, wherein the disparity determination unit is configured to determine the disparity of the determined sub-pixel arrangement so that a value obtained by multiplying a value representing the disparity when the sub-pixel arrangement is determined to be the first arrangement by an absolute value of a tangent function of an angle indicated by the angle information and a value representing the disparity when the sub-pixel arrangement is determined to be the second arrangement are the same value.

3. The image processing apparatus according to claim 1, wherein the disparity determination unit determines the disparity of the determined sub-pixel arrangement so as to satisfy the following formula,
Dispᵥ=Dispₕ·|tan θ|

wherein Dispᵥ represents the disparity when the sub-pixel arrangement is determined to be the second arrangement, Dispₕ represents the disparity when the sub-pixel arrangement is determined to be the first arrangement, and θ represents the angle of the parallax element.

4. The image processing apparatus according to claim 1, wherein the image generation unit generates a same number of images of other viewpoints when the sub-pixel arrangement is determined to be the first arrangement as when the sub-pixel arrangement is determined to be the second arrangement.

5. The image processing apparatus according to claim 1, wherein the image generation unit generates fewer images of other viewpoints when the sub-pixel arrangement is determined to be the second arrangement than a number of images of other viewpoints generated when the sub-pixel arrangement is determined to be the first arrangement.

6. An image processing apparatus comprising:
an arrangement determination unit configured to determine whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen; and
a disparity determination unit configured to determine a disparity of the determined sub-pixel arrangement based on angle information representing an angle at which a parallax element is provided with respect to a reference direction of the display screen and a determination result of the sub-pixel arrangement,
wherein a disparity of images of adjacent viewpoints based on a disparity determined when the sub-pixel arrangement is determined to be the second arrangement is greater than a disparity of images of adjacent viewpoints based on a disparity determined when the sub-pixel arrangement is determined to be the first arrangement.

7. An image processing method comprising:
determining whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen;
determining a disparity of the determined sub-pixel arrangement based on angle information representing an angle at which a parallax element is provided with respect to a reference direction of the display screen and a determination result of the sub-pixel arrangement; and
generating, based on the determined disparity and an image signal, one or two or more images of other viewpoints that are different to a viewpoint of an image represented by the image signal,
wherein in the determination of disparity, a disparity determined when the sub-pixel arrangement is determined to be the second arrangement is set to be greater than a disparity determined when the sub-pixel arrangement is determined to be the first arrangement.

8. A program that causes a computer to execute:
determining whether an arrangement of sub-pixels forming pixels of a display screen is a first arrangement in which a short dimension of the sub-pixels is arranged so as to be in a horizontal direction of the display screen, or a second arrangement in which a long dimension of the sub-pixels is arranged so as to be in the horizontal direction of the display screen;
determining a disparity of the determined sub-pixel arrangement based on angle information representing an angle at which a parallax element is provided with respect to a reference direction of the display screen and a determination result of the sub-pixel arrangement; and
generating, based on the determined disparity and an image signal, one or two or more images of other viewpoints that are different to a viewpoint of an image represented by the image signal,
wherein in the determination of disparity, a disparity determined when the sub-pixel arrangement is determined to be the second arrangement is set to be greater than a disparity determined when the sub-pixel arrangement is determined to be the first arrangement.
